(19) United States
(12) Patent Application Publication
(10) Pub. No.: US 2021/0231516 A1
(43) Pub. Date: Jul. 29, 2021

(54) Leak Detection System and Method

(71) Applicant: Water Hero LLC, Beverly, MA (US)

(72) Inventors: Daniel Sterling, North Palm Beach, FL (US); Victor Berry, Ashburnham, MA (US); Eric Koetsch, Gardner, MA (US); Christopher Phillips, Walpole, MA (US)

(21) Appl. No.: 17/161,516

(22) Filed: Jan. 28, 2021

Related U.S. Application Data
(60) Provisional application No. 62/967,163, filed on Jan. 29, 2020.

(51) Int. Cl. G01M 3/00; G01M 3/28

(52) U.S. Cl. CPC G01M 3/007; G01M 3/2876

(57) ABSTRACT

A leak detection system and method configured for closed fluid circulation systems is described in this application. The leak detection system can use at least two sensors plumbed into the closed fluid circulation system to determine whether the closed system contains a leak. The leak detection system can optionally include fluid loss mitigation valves, fill valves, drain valves and bleed valves to add additional functionality.

### CROSS REFERENCE TO RELATED APPLICATIONS

This application claims the benefit of U.S. Provisional Patent Application No. 62/967,163 filed Jan. 29, 2020, which is hereby incorporated by reference in its entirety.

### FIELD

The present disclosure relates to leak detection systems in closed fluid circulation systems.

### BACKGROUND

Examples of closed fluid circulation systems include, but are not limited to, hot oil circuits, cooling/chilled water systems, hot water heating or hydronic heating systems and air conditioning systems. Where closed fluid circulation systems are used, it is desirable to be able to detect leaks, mitigate leak damage by containing the leak and locate leaks in the system.

### BRIEF SUMMARY

The present disclosure includes a leak detection system and a method of leak detection in closed fluid circulation systems (hereinafter, the “system” and the “method”). The system can include two or more sensors, including but not limited to, flow or pressure sensors, at two different positions of the closed fluid circulation system. The sensors can be positioned at opposite ends of the closed fluid circulation system to provide data from various locations. The sensors can be calibrated to ensure that they provide synchronized results. When all sensors are synchronized, there is no loss of fluid occurring in the closed fluid circulation system. When the sensors provide different values, a leak is detected and reported to a user console.

The system can include valves to mitigate the loss of a fluid from a closed fluid circulation system.

### BRIEF DESCRIPTION OF THE SEVERAL VIEWS OF THE DRAWINGS

FIG. 1 is a system diagram of the system incorporated into a closed fluid circulation system.

FIG. 2 is a system diagram of the system with loss mitigation valves incorporated into a closed fluid circulation system.

FIG. 3 is a flow chart depicting a method of leak detection, fluid loss mitigation and leak detection.

FIG. 4 is a system diagram of the system with loss mitigation valves and a drain valve incorporated into a closed fluid circulation system.

FIG. 5 is a system diagram of the system with a bleed valve incorporated into a closed fluid circulation system.

FIG. 6 is a system diagram of the system with loss mitigation valves, a fill valve and a drain valve incorporated into a closed fluid circulation system.

FIG. 7 is a system diagram of the system with loss mitigation valves, a fill valve and a bleed valve incorporated into a closed fluid circulation system.

### DETAILED DESCRIPTION

The present disclosure relates to closed fluid circulation systems where it is desirable to identify and locate leaks.

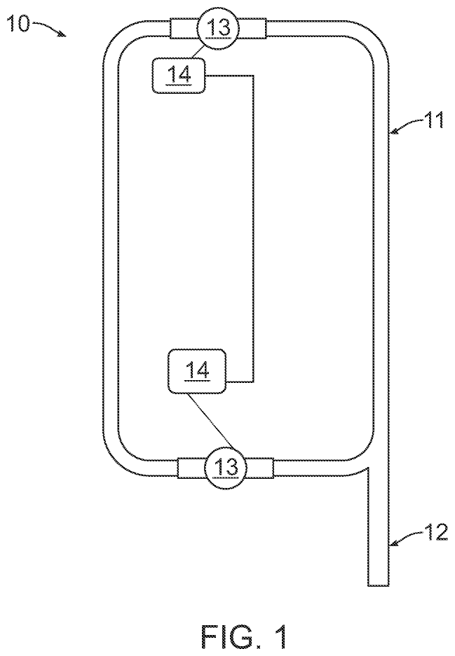

In conventional closed fluid circulation systems, leaks are not detected until fluid is visually seen vacating the system in an abnormal manner. The leak detection system 10 can be capable of detecting minor leaks before they cause property damage. The system 10 in FIG. 1 can comprise at least two sensors 13 at two different positions of the closed fluid circulation system piping 11. The at least two sensors 13 can be fixed at opposite end of the closed fluid circulation system piping 11. The sensors 13 can be connected to one or more controllers 14 that process data generated by the sensors 13. The sensors 13 can comprise any type of sensor capable of detecting an abnormality within closed fluid circulation system, including, but not limited to, flow sensors, pressure sensors and flow and pressure sensors. The closed fluid circulation system piping 11 can optionally include a branch pipe 12.

The system 10 detects parameters from the sensors 13 at various locations on the closed fluid circulation system piping 11. When no leak is present, the data sent by the sensors 13 to the controllers 14 is within a predetermined tolerance of one another. Synchronized, as used herein, refers to when the data sent by the sensors 13 is within a predetermined tolerance or one another. The predetermined tolerance can be adjusted based on the volume of the closed fluid circulation system piping 11. In larger closed fluid circulation systems, it may be desirable to calibrate the system 10 to be less sensitive (i.e., have a larger predetermined tolerance). In smaller closed fluid circulation systems with a lower volume, it may be desirable to calibrate the system 10 to be more sensitive (i.e., have a smaller predetermined tolerance). The system 10 can be calibrated to detect differences from the sensors 13 based on the loss of a predetermined amount of fluid. When calibrated for the loss of a predetermined amount of fluid, a leak can be determined when a few tenths of a gallon, for example, are lost from the closed fluid circulation piping 11.

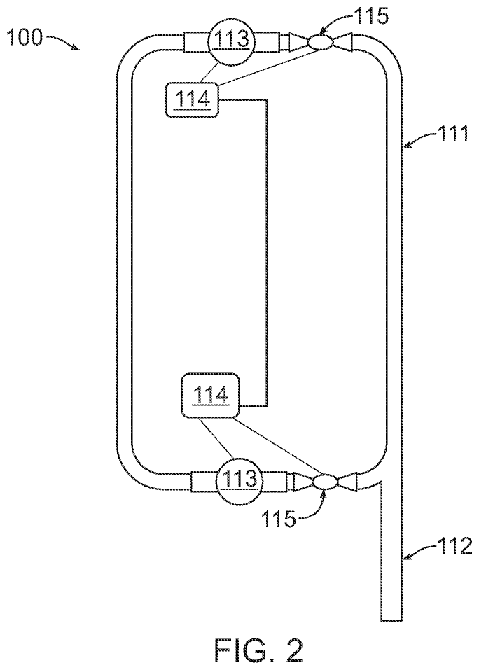

In FIG. 2 is a system diagram of the system 100 with loss mitigation valves 115 incorporated into a closed fluid circulation system 111. The system 100 can comprise at least two sensors 113 at two different positions of the closed fluid circulation system piping 111. The at least two sensors 113 can be fixed at opposite end of the closed fluid circulation system piping 111. The system 100 can also comprise loss mitigation valves 115 in fluid communication with the fluid circulation system piping 111 and fixed at two different positions of the closed fluid circulation system piping 111. The loss mitigation valves 115 can be fixed at opposite end of the closed fluid circulation system piping 111. The sensors 113 and loss mitigation valves 115 can be connected to one or more controllers 114 that process data generated by the sensors 113 and operate the loss mitigation valves 115. The sensors 113 can comprise any type of sensor capable of detecting an abnormality within closed fluid circulation system, including, but not limited to, flow sensors, pressure sensors and flow and pressure sensors. The loss mitigation valves 115 can comprise any type of device that is configured to remotely close fluid communication from one side of the device to the other side of the device. The closed fluid circulation system piping 111 can optionally include a branch pipe 112.

In the system 100, when the sensors 113 detect a leak through non-synchronized values, the controllers 114 can direct the loss mitigation valves 115 to stop fluid communication across the valves 115 to mitigate the loss of fluid from the system 100.

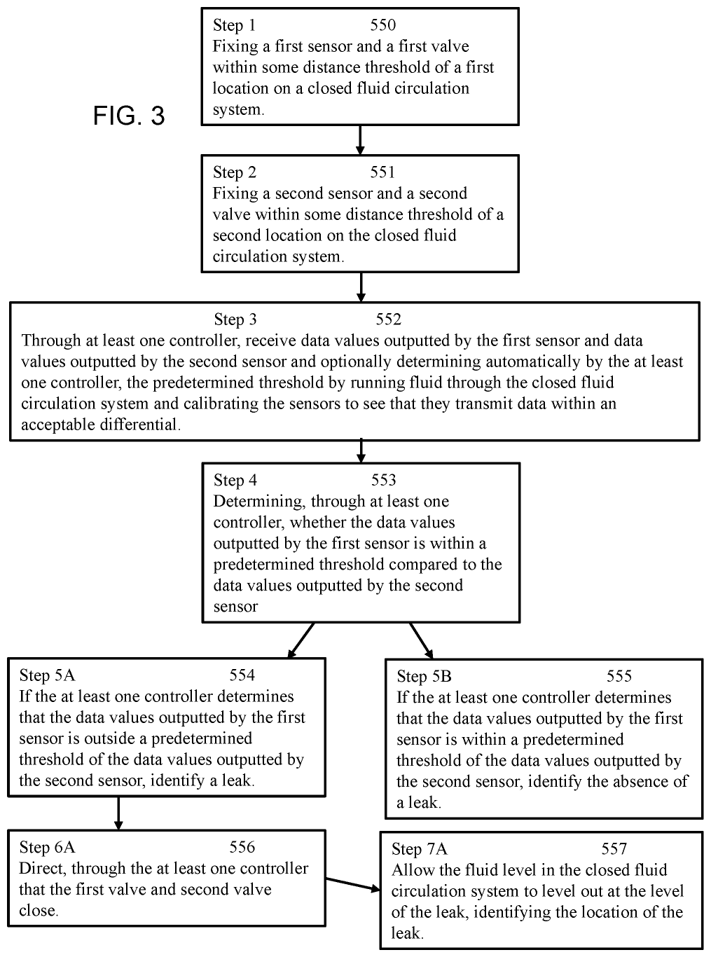

In FIG. 3 is a flow chart depicting a method of leak detection, fluid loss mitigation and leak detection. The aforementioned method can begin with a step 1 550 where a first sensor a first sensor and a first valve are fixed within some distance threshold of a first location on a closed fluid circulation system. The distance threshold depends on the size of the closed fluid circulation system. On larger closed fluid circulation systems, the distance threshold can be increased to account for larger piping, sensors and valves. On smaller closed fluid circulation systems, the distance threshold may be decreased to account for the size of the piping, sensors and valves. A step 2 551 can include fixing a second sensor and a second valve within some distance threshold of a second location on the closed fluid circulation system. A step 3 552 can include: through at least one controller, receiving data values outputted by the first sensor and data values outputted by the second sensor. A step 4 553 can include: determining, through at least one controller, whether the data values outputted by the first sensor is within a predetermined threshold compared to the data values outputted by the second sensor. The predetermined threshold can be decided based on the size of the closed fluid circulation system. The predetermined threshold, as used herein, can be determined based on the size and volume of the particular closed fluid circulation system. A very large closed fluid circulation system may require a higher threshold, while a very small closed fluid circulation system may require a lower threshold. In step 3 552, the predetermined threshold can be determined automatically by a controller in the system by running fluid through the closed fluid circulation system and calibrating the sensors to see that they transmit data within an acceptable differential.

The aforementioned method then determines whether a leak has occurred in the closed fluid circulation system in steps 5A 554 and 5B 555. In a step 5A 554, if the at least one controller determines that the data values outputted by the first sensor is outside a predetermined threshold of the data values outputted by the second sensor, the system identifies a leak. In a step 5B, if the at least one controller determines that the data values outputted by the first sensor is within a predetermined threshold of the data values outputted by the second sensor, the system identifies the absence of a leak. The absence of a leak indicates normal operation of the closed fluid circulation system and method will return to step 3 552 for continued monitoring.

When a leak is identified in step 5A 554, the leak can be mitigated through step 6A 556 by directing, through the at least one controller that the first valve and second valve close. After mitigating the leak in step 6A 556, the location of the leak can be identified in step 7A 557 by allowing the fluid level in the closed fluid circulation system to level out at the level of the leak, identifying the location of the leak.

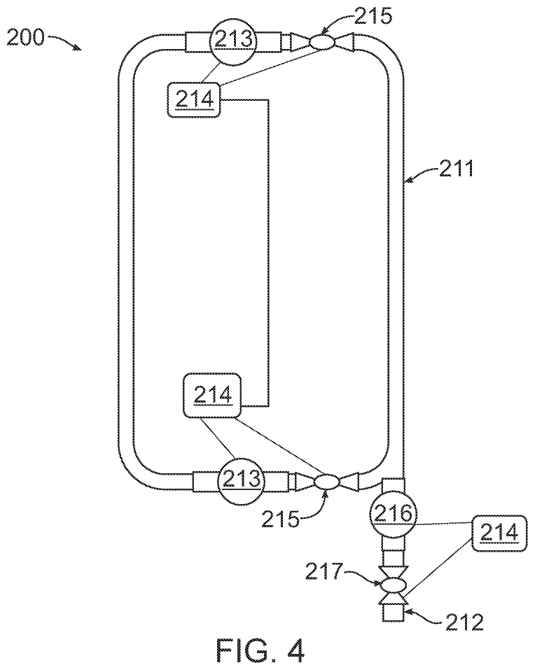

In FIG. 4 is a system diagram of the system 200 with loss mitigation valves 215 and a drain valve 217 incorporated into a closed fluid circulation system 211. The system 200 can comprise at least two sensors 213 at two different positions of the closed fluid circulation system piping 211. The at least two sensors 213 can be fixed at opposite end of the closed fluid circulation system piping 211. The system 200 can also comprise loss mitigation valves 215 in fluid communication with the fluid circulation system piping 211 and fixed at two different positions of the closed fluid circulation system piping 211. The loss mitigation valves 215 can be fixed at opposite end of the closed fluid circulation system piping 211. The sensors 213 and loss mitigation valves 215 can be connected to one or more controllers 214 that process data generated by the sensors 213 and operate the loss mitigation valves 215. The sensors 213 can comprise any type of sensor capable of detecting an abnormality within closed fluid circulation system, including, but not limited to, flow sensors, pressure sensors and flow and pressure sensors. The loss mitigation valves 215 can comprise any type of device that is configured to remotely close fluid communication from one side of the device to the other side of the device. The closed fluid circulation system piping 211 can optionally include a branch pipe 212.

The branch pipe 212 can comprise a drain sensor 216 and a drain valve 217 in fluid communication with the branch pipe 212. The drain sensor 216 and drain valve 217 are operably connected to a controller 214 configured to process data from the drain sensor 216 and remotely operate the drain valve 217. Similar to sensors 213, the drain sensor 216 can comprise any type of sensor capable of detecting an abnormality within closed fluid circulation system, including, but not limited to, flow sensors, pressure sensors and flow and pressure sensors.

In the system 200, when the sensors 213 detect a leak through non-synchronized values, the controllers 214 can direct the loss mitigation valves 215 to stop fluid communication across the valves 215 to mitigate the loss of fluid from the system 200. When the loss mitigation valves 215 are closed, the amount of fluid in the fluid circulation system piping 211 will level out at the point of a leak, providing valuable information about the location of the leak. Once the location of the leak is identified, the fluid circulation system piping 211 can be drained using the drain valve 217. The amount of fluid drained by the drain valve 217 can optionally be measured by the drain sensor 216 to calculate the amount of fluid lost from the fluid circulation system piping 211.

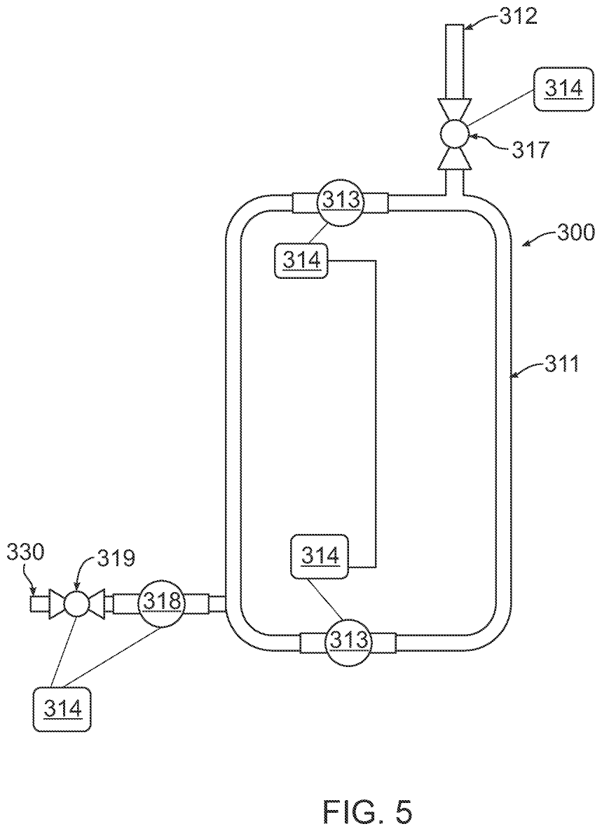

In FIG. 5 is a system diagram of the system 300 with a bleed valve 317 incorporated into a closed fluid circulation system 311. The system 300 in FIG. 5 can comprise at least two sensors 313 at two different positions of the closed fluid circulation system piping 311. The at least two sensors 313 can be fixed at opposite end of the closed fluid circulation system piping 311. The sensors 313 can be connected to one or more controllers 314 that process data generated by the sensors 313. The sensors 313 can comprise any type of sensor capable of detecting an abnormality within closed fluid circulation system, including, but not limited to, flow sensors, pressure sensors and flow and pressure sensors. The closed fluid circulation system piping 311 can optionally include a branch pipe 312. The branch pipe 312 can be located towards the top of the closed fluid circulation system piping 311 and can comprise a bleed valve 317 in fluid communication with the branch pipe 312. The bleed valve 317 can be operably connected to a controller 314, which can be configured to remotely operate the bleed valve 317. The bleed valve 317 can comprise any type of device that is configured to remotely close fluid communication from one side of the device to the other side of the device. The bleed valve 317 and controller 314 in fluid communication with the upwardly mounted branch pipe 312 can be beneficial in some closed fluid circulation system piping 311 systems to eliminate air or undesirable fluids from the system piping 311.

The system 300 detects parameters from the sensors 313 at various locations on the closed fluid circulation system piping 311. When no leak is present, the data sent by the sensors 313 to the controllers 314 is within a predetermined tolerance. Synchronized, as used herein, refers to when the data sent by the sensors 313 is within a predetermined tolerance.

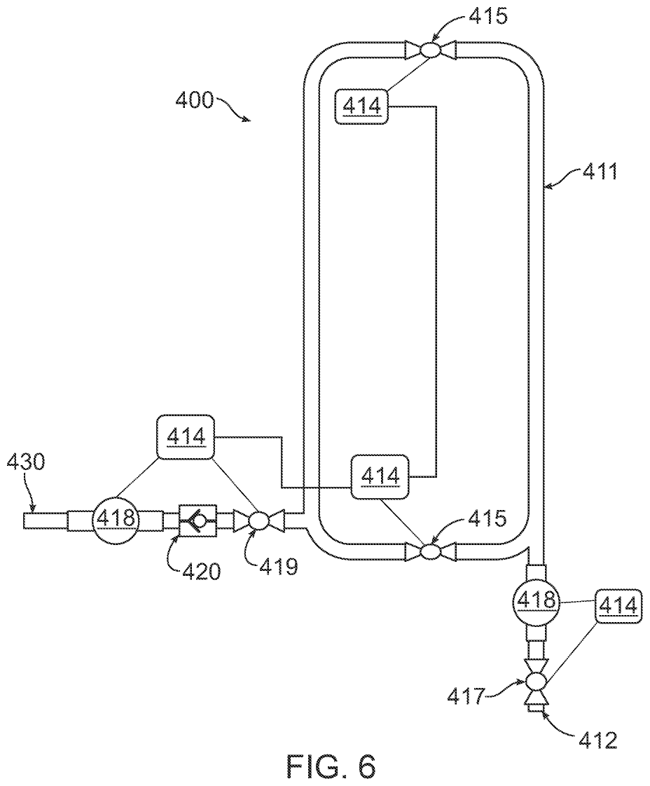

In FIG. 6 is a system diagram of the system 400 with loss mitigation valves 415, a fill line 430 and a drain valve 417 incorporated into a closed fluid circulation system 411. The system 400 can comprise loss mitigation valves 415 in fluid communication with the fluid circulation system piping 411 and fixed at two different positions of the closed fluid circulation system piping 411. The at least two sensors 413 can be fixed at opposite end of the closed fluid circulation system piping 411. The loss mitigation valves 415 can be connected to one or more controllers 414 that operate the loss mitigation valves 415. The loss mitigation valves 415 can comprise any type of device that is configured to remotely close fluid communication from one side of the device to the other side of the device. The closed fluid circulation system piping 411 can optionally include a branch pipe 412.

The branch pipe 412 can comprise a drain sensor 416 and a drain valve 417 in fluid communication with the branch pipe 412. The drain sensor 416 and drain valve 417 are operably connected to a controller 414 configured to process data from the drain sensor 416 and remotely operate the drain valve 417. Similar to sensors 213, the drain sensor 416 can comprise any type of sensor capable of detecting an abnormality within closed fluid circulation system, including, but not limited to, flow sensors, pressure sensors and flow and pressure sensors. Sensor 416 is preferably a flow sensor and most preferably a fire-rated flow sensor.

The fill line 430 can comprise a sensor 418, a check valve 420 and valve 419, all in fluid communication with the fill line 430 on one end and the fluid circulation system piping 411 on the other end. The sensor 418 can comprise any type of sensor capable of detecting an abnormality within closed fluid circulation system, including, but not limited to, flow sensors, pressure sensors and flow and pressure sensors. Sensor 418 is preferably a flow sensor and most preferably a fire-rated flow sensor. Check valve 420 can comprise any type of device that prevents the flow of a fluid from the fluid circulation system piping 411 to the fill line 430. The valve 419 can comprise any type of device that is configured to remotely close fluid communication from one side of the device to the other side of the device. The sensor 418 and valve 419 can be operably connected to a controller 414 configured to process data from the sensor 418 and remotely control the valve 419.

In the system 400, the controllers 414 can direct the loss mitigation valves 415 to stop fluid communication across the valves 415 to mitigate the loss of fluid from the system 400. When the loss mitigation valves 415 are closed, the amount of fluid in the fluid circulation system piping 411 will level out at the point of a leak, providing valuable information about the location of the leak. Once the location of the leak is identified, the fluid circulation system piping 411 can be drained using the drain valve 417. The amount of fluid drained by the drain valve 417 can optionally be measured by the drain sensor 416 to calculate the amount of fluid lost from the fluid circulation system piping 411.

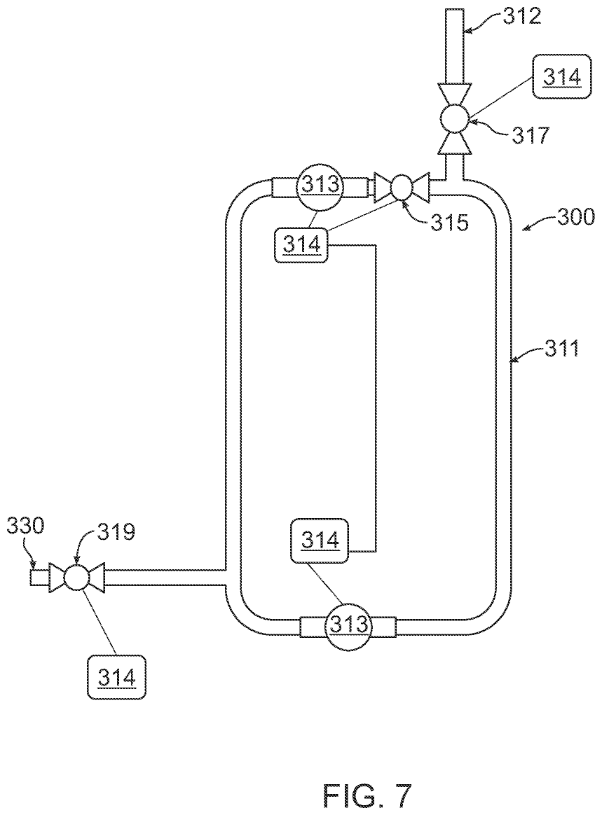

In FIG. 7 is a system diagram of the system 300 with a loss mitigation valve 315, a fill valve 319 and a bleed valve 317 incorporated into a closed fluid circulation system.

The system 300 in FIG. 7 can comprise at least two sensors 313 at two different positions of the closed fluid circulation system piping 311. The at least two sensors 313 can be fixed at opposite end of the closed fluid circulation system piping 311. The system 311 can comprise a loss mitigation valve 315. The sensors 313 and loss mitigation valve 315 can be connected to one or more controllers 314 that process data generated by the sensors 313 and remotely operate the loss mitigation valve 315. The sensors 313 can comprise any type of sensor capable of detecting an abnormality within closed fluid circulation system, including, but not limited to, flow sensors, pressure sensors and flow and pressure sensors. The closed fluid circulation system piping 311 can optionally include a branch pipe 312. The branch pipe 312 can be located towards the top of the closed fluid circulation system piping 311 and can comprise a bleed valve 317 in fluid communication with the branch pipe 312. The bleed valve 317 can be operably connected to a controller 314, which can be configured to remotely operate the bleed valve 317. The bleed valve 317 can comprise any type of device that is configured to remotely close fluid communication from one side of the device to the other side of the device. The bleed valve 317 and controller 314 in fluid communication with the upwardly mounted branch pipe 312 can be beneficial in some closed fluid circulation system piping 311 systems to eliminate air or undesirable fluids from the system piping 311.

The system 300 can also comprise a fill line 330 in fluid communication with a first side of a fill valve 319, where a second side of the fill valve 319 is in fluid communication with the closed fluid circulation system piping 311. The fill valve 319 can be operably connected to a controller 314 configured to remotely operate the fill valve 319.

The system 300 detects parameters from the sensors 313 at various locations on the closed fluid circulation system piping 311. When no leak is present, the data sent by the sensors 313 to the controllers 314 is within a predetermined tolerance. Synchronized, as used herein, refers to when the data sent by the sensors 313 is within a predetermined tolerance.

What has been described is a system and method of leak detection in closed fluid circulation systems. In this disclosure, there is shown and described only the preferred embodiments of the invention, but, as aforementioned, it is to be understood that the invention is capable of use in various other combinations and environments and is capable of changes or modifications within the scope of the inventive concept as expressed herein.

What is claimed is:

1. A fluid leak detection system, comprising:
a closed fluid circulation system;
a first sensor mounted at a first position on the closed fluid circulation system to generate data values;
a second sensor mounted at a second location on the closed fluid circulation system to generate data values;
a first valve mounted at a distance within a threshold to the first position of the closed fluid circulation system; and
at least one controller operably connected to the first sensor and second sensor, to detect differences in data values generated by the at least two sensors, and connected to the first valve to operate the valve.

2. The system of claim 1, wherein the at least two sensors are mounted at opposite ends of the closed fluid circulation system.

3. The system of claim 2, further comprising a second valve mounted within a distance threshold to the second position of the closed fluid circulation system and operably connected to the at least one controller to operate the second valve.

4. The system of claim 1, wherein the system determines whether a leak exists in the closed fluid circulation system by the at least one controller comparing the data values outputted by the first sensor against the data values outputted by the second sensor.

5. The system of claim 4, wherein the system concludes that no leak exists when the at least one controller comparing the data outputted by the first sensor against the data outputted by the second sensor determines that they are within a predetermined threshold.

6. The system of claim 3, wherein the sensors comprise one of a flow sensor, a pressure sensor and a flow and pressure sensor.

7. The system of claim 6, further comprising a first branch pipe in fluid communication with the closed fluid circulation system.

8. The system of claim 7, further comprising a third valve mounted to the first branch pipe and operably connected to the at least one controller to operate the third valve.

9. The system of claim 8, further comprising a third sensor mounted to the first branch pipe and operably connected to the at least one controller to receive data values from the third sensor.

10. The system of claim 9, further comprising:
a second branch pipe in fluid communication with the closed fluid circulation system;
a fourth valve mounted to the second branch pipe and operably connected to the at least one controller to operate the third valve; and
a fourth sensor mounted to the second branch pipe and operably connected to the at least one controller to receive data values from the fourth sensor.

11. A method of leak detection, comprising:
fixing a first sensor and a first valve within some distance threshold of a first location on a closed fluid circulation system;
fixing a second sensor and a second valve within some distance threshold of a second location on the closed fluid circulation system;
through at least one controller, receiving data values outputted by the first sensor and data values outputted by the second sensor;
determining, through the at least one controller, whether the data values outputted by the first sensor are within a predetermined threshold compared to the data values outputted by the second sensor.

12. The method of claim 11, further comprising a method of leak mitigation:
directing, through the at least one controller, the first valve to close.

13. The method of claim 12, the method of leak mitigation further comprising:
directing, through the at least one controller, the second valve to close.

14. The method of claim 13, further comprising a method of leak identification:
allowing a fluid level in the closed fluid circulation system to level out at the level of the leak, identifying the location of the leak.

15. The method of claim 11, further comprising the step of automatically determining the predetermined threshold, using the at least one controller, by running a fluid through the closed fluid circulation system and calibrating the first and second sensor to verify that they transmit data within an acceptable differential.
